(19) United States
(12) Patent Application Publication
(10) Pub. No.: US 2009/0029734 A1
(43) Pub. Date: Jan. 29, 2009

(54) Mobile communication device and system with modular audio accessory

(75) Inventor: Masood Syed, Mission Viejo, CA (US)

Correspondence Address: FARJAMI & FARJAMI LLP, 26522 LA ALAMEDA AVENUE, SUITE 360, MISSION VIEJO, CA, 92691, US

(73) Assignee: BROADCOM CORPORATION, IRVINE, CA (US)

(21) Appl. No.: 11/880,824

(22) Filed: Jul. 23, 2007

(51) Int. Cl. H04B 1/38

(52) U.S. Cl. 455/557

(57) ABSTRACT

There is provided a mobile communication system that comprises a mobile communication device having a first battery and a compartment, the compartment having a power port. The mobile communication system further comprises a modular accessory including a second battery, where the modular accessory is configured for placement in the compartment, such that the second battery can be connected to the power port. The second battery can be charged through the power port when the modular audio accessory is placed in the compartment. In one aspect, the power port connects the first battery to the second battery. In another aspect, the power port provides power to the second battery without connecting the first battery to the second battery. Further, the mobile communication system may include a single charger for concurrently charging both the first battery to the second battery.

### BACKGROUND OF THE INVENTION

1. Field of the Invention

The present invention relates generally to communications devices and systems. More particularly, the present invention relates to devices and systems used for mobile communications.

2. Background Art

Mobile communication devices are widely used and heavily relied upon by substantially all strata of modem society for activities ranging from socialization to commercial transaction. Although at one time the perceived advantages of mobile communications may have focused on the convenience and enhanced personal security flowing from an ability to communicate more or less independently of location, other benefits are heavily emphasized today. For example, mobile communication devices are increasingly being utilized to enable multi-tasking activities. Mobile telephones, for instance, once used primarily to communicate from a remote location, are now frequently used to communicate while traveling to and from a remote location, or while performing a task in a remote location. To draw a specific example from common experience, the sight of drivers simultaneously using cellular telephones while operating an automobile has become ubiquitous on the roads and freeways.

While enabling greater productivity, the use of mobile communication devices to multi-task includes some undesirable consequences. At their most benign, these consequences include inconveniences associated with the hands-on aspect of operating a mobile device while performing, or trying to perform, a routine task. More ominous, however, are the very real safety concerns, both to device users and to bystanders, arising from their use during the performance of potentially dangerous activities. In response to those concerns, several states and municipalities have enacted laws prohibiting the use of mobile communication devices while driving a motor vehicle, for example.

Conventional solutions for making mobile devices safer and more convenient to use, rely on systems utilizing wired or wireless headsets to permit hands-free operation of the device. As an example of a conventional implementation for hands-free mobile communication, FIG. 1 shows a conventional mobile communication system including a conventional mobile telephone and a conventional mobile headset. Mobile communication system 100 in FIG. 1 includes mobile telephone 102 equipped with phone battery 104, and external phone charger 106. Also shown in FIG. 1 is mobile headset 108, having battery 110 and power connector 112 for connection to external headset charger 114. Mobile headset 108 may comprise a Bluetooth device, for example.

Typical operation of mobile communication system 100 requires that mobile telephone 102 and mobile headset 108 be separately charged by respectively, external phone charger 106 and external headset charger 114. When both mobile telephone 102 and mobile headset 108 are charged and synchronized with one another, the two devices may communicate using radio frequency, in a manner well known in the art, to enable hands-free operation of mobile telephone 102. Depletion of the power stored in either phone battery 104, in mobile telephone 102, or battery 110, in mobile headset 108, however, terminates hands-free operation, and requires replenishment of the depleted battery charge by the respective external charger prior to resumption of hands-free use.

A primary advantage provided by this conventional implementation is that hands-free operation of mobile telephone 102 is, in principle, enabled. However, drawbacks associated with this conventional implementation have significant practical consequences that compromise effective enablement. For example, the conventional implementation tends to be cumbersome and lack portability due to its reliance on separate external chargers for the mobile telephone 102 and the mobile headset 108. As a result, to be fully portable, the system requires access to two separate external chargers, which must consequently be carried by the user of the system. Otherwise, the usefulness of the system is limited by the operational capacity of the component device with the least functional longevity between charges, typically the mobile headset in standby mode, because of its smaller battery.

Battery size has additional implications for the mobile headset because a lower limit on its physical dimensions may be determined by the size of the battery needed to power it for an operationally desirable period of time. Because the conventional implementation typically requires a mobile headset battery to store a charge sufficient for multiple uses, a mobile headset must be large enough to physically accommodate a battery having the required capacity. Moreover, by relying on separate external charging devices for mobile telephone 102 and mobile headset 108, the conventional implementation requires at least four discrete component devices for uninterrupted operation of the mobile communication system. The practical disadvantage to that constraint includes sub-optimal mobile communication system portability, as mentioned previously, as well as vulnerability of the system as a whole to loss or misplacement of just one of those four required component devices—a scenario made ever more likely by the constantly increasing proliferation of gadgets an average user may be expected to possess.

### SUMMARY OF THE INVENTION

A mobile communication device and system with modular audio accessory, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows a conventional mobile communication system including a conventional mobile telephone and a conventional mobile headset;

FIG. 2A shows a mobile communication system with a modular audio accessory, according to one embodiment of the present invention;

FIG. 2B shows the mobile communication system of FIG. 2A with its modular audio accessory contained by the handset, according to one embodiment of the present invention; and

FIG. 3 shows a mobile communication system with a modular audio accessory, according to another embodiment of the present invention.

### DETAILED DESCRIPTION OF THE INVENTION

The present invention is directed to a mobile communication device and system with modular audio accessory. Although the invention is described with respect to specific embodiments, the principles of the invention, as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely example embodiments of the invention. To maintain brevity, other embodiments of the invention, which use the principles of the present invention, are not specifically described in the present application and are not specifically illustrated by the present drawings. It should be borne in mind that, unless noted otherwise, like or corresponding elements among the figures may be indicated by like or corresponding reference numerals.

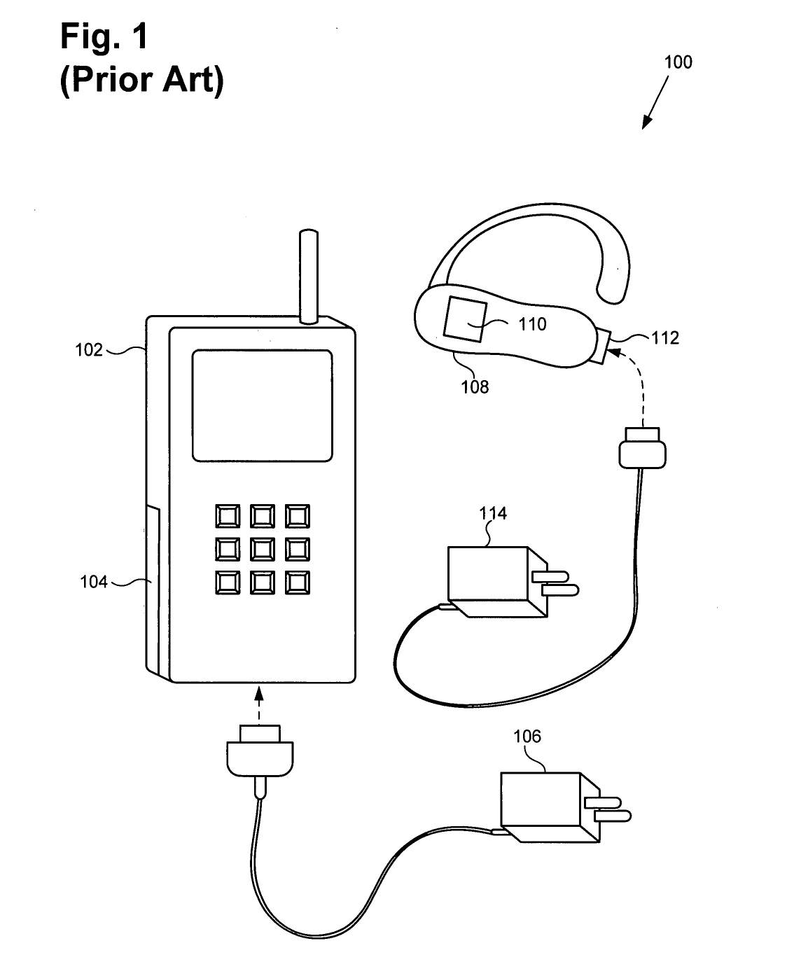

As discussed previously in conjunction with FIG. 1, conventional implementations of mobile communication systems supporting hands-free operation suffer from multiple disadvantages. Those disadvantages include sub-optimal portability due to the number of discrete component devices required for uninterrupted operation, and bulkiness of the mobile headset due to the multiple use storage capacity required of the headset battery. In addition, operability of the mobile communication system as a whole is vulnerable to loss, misplacement, or discharge of the discrete component devices comprising the mobile system, and shown in FIG. 1.

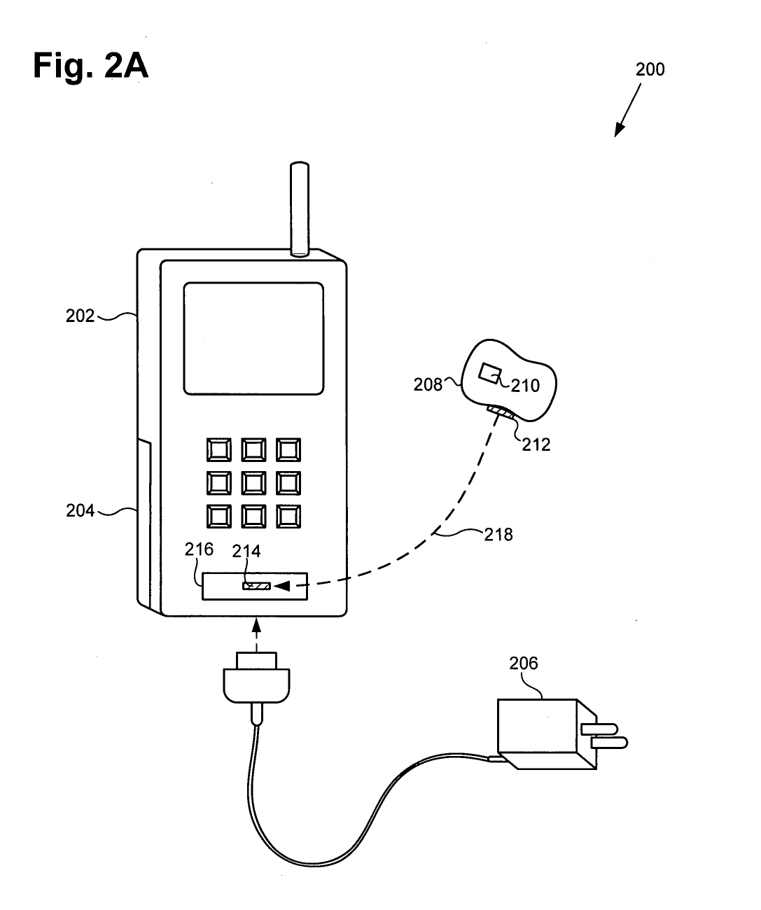

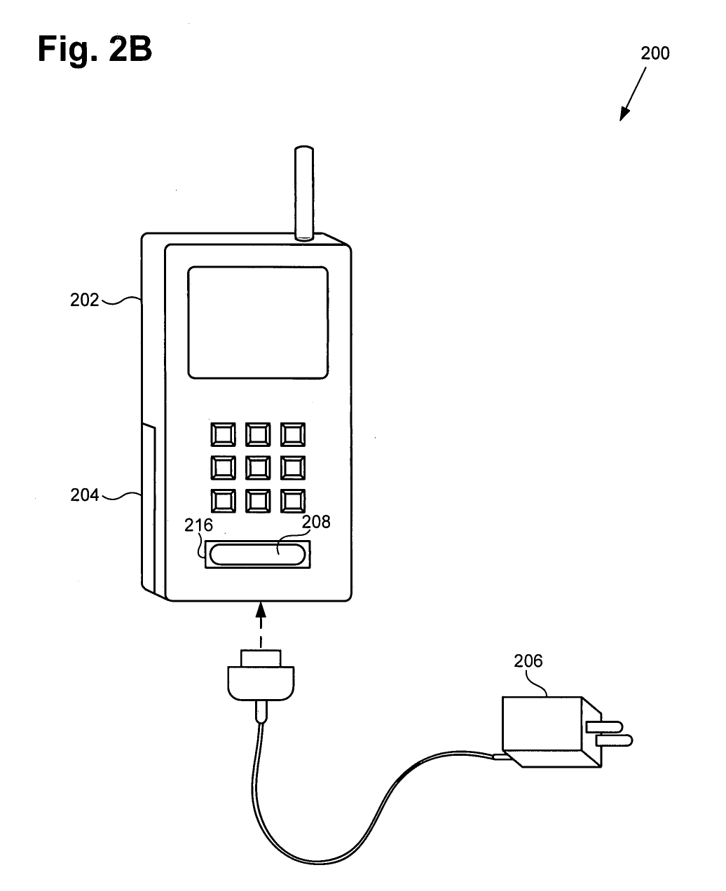

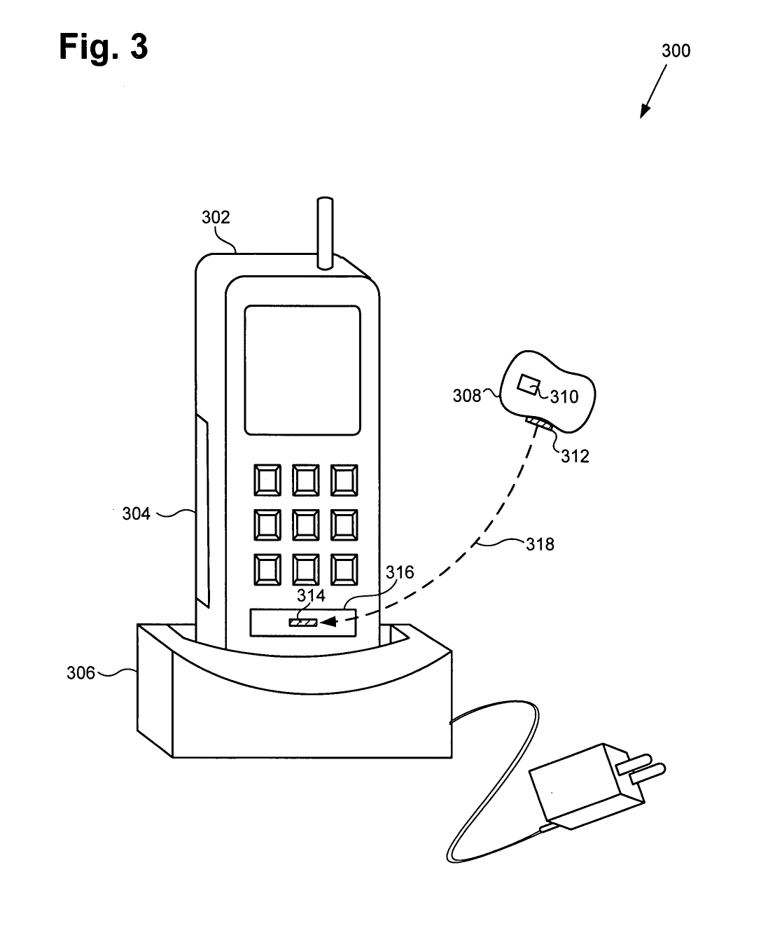

FIG. 2A shows mobile communication system 200 with modular audio accessory 208, according to one embodiment of the present invention, which provides various advantages, such as an integrated power supply, reduced size, and improved portability. It should be noted that FIG. 2A and the following FIGS. 2B and 3 are for the purpose of providing an overview, and elements shown in FIGS. 2A, 2B, and 3 are conceptual representations of physical and electrical elements, and are thus not intended to show dimensions or relative sizes or scale.

In the embodiment of FIG. 2A, mobile communication system 200 includes mobile telephone 202 equipped with phone battery 204, and external phone charger 206. Also shown in FIG. 2A is modular audio accessory 208, having battery 210 and power connector 212. As further shown in FIG. 2A, mobile communication system 200 also includes power port 214 and compartment 216.

According to the present embodiment, modular audio accessory 208, which can be for example, a wireless headset, wireless earpiece, or a Bluetooth device, can be stored, when not in use, by placement into compartment 216 in mobile telephone 202. In addition, power connector 212 on modular audio accessory 208 can be connected to power port 214, located in compartment 216, wherein battery 210 is charged by phone battery 204. Dashed line 218 in FIG. 2A indicates that storage and charging configuration, as well as the fact that modular audio accessory 208 may be readily removed from compartment 216 for use.

In the event that phone battery 204 becomes depleted, it may be charged using phone charger 206, in which event battery 210 of modular audio accessory 208 is charged through phone battery 204, when connected to power port 214. Yet, in other embodiments, battery 210 of modular audio accessory 208 may directly be connected to phone charger 206 through power port 214 for charging battery 210. It should also be noted that, unlike mobile communication system 100 in FIG. 1, mobile communication system 200 in FIG. 2A does not need an external headset charger. However, in other embodiments, an external headset charger may additionally be used for charging battery 210.

Although in the present embodiment, modular audio accessory 208 is utilized in conjunction with mobile telephone 202, in other embodiments modular audio accessory 208 can be utilized with other mobile communication devices. Those alternative mobile communication devices may include, but are not limited to, cellular telephones, cordless telephone handsets, wireless computers, personal digital assistants (PDAs), digital audio players, and video game consoles, for example.

FIG. 2B shows the mobile communication system of FIG. 2A with its modular audio accessory contained by the handset, according to one embodiment of the present invention. Mobile communication system 200 in FIG. 2B illustrates how, in one embodiment, the entire modular audio accessory 208 is inserted into compartment 216 and connected to power port 214 (not shown in FIG. 2B). Of course, in other embodiments, a portion of modular audio accessory 208 may protrude from compartment 216.

As may be seen from FIG. 2B, because modular audio accessory 208 can be placed into compartment 216, connected to power port 214, and charged through phone battery 204, modular audio accessory 208 can be securely stored in mobile telephone 202 when modular accessory 208 is not in use. As a result, modular audio accessory 208 functions as a modular component of mobile telephone 202, rather than as a discrete device as in conventional implementations. Consequently, according to an embodiment of the present embodiment, modular audio accessory 208 may be integrated into mobile telephone 202, effectively merging the burdens associated with its storage, charging, and transport, with those of mobile telephone 202. Thus, mobile system 200, which captures the full functionality of conventional mobile system 100, has fewer discrete components and a fully integrated power source, making mobile communication system 200 more portable and less susceptible to inoperability due to lost, misplaced, or discharged component devices.

Comparison of the mobile communication systems shown in FIGS. 1, 2A, and 2B reveals an additional advantage of the present invention. As discussed in conjunction with FIG. 1, the physical size of mobile headset 108 is to some extent determined by the size of battery 110, which typically is selected to have sufficient capacity to support multiple uses of mobile headset 108 between charges. In the embodiment of FIGS. 2A and 2B, by contrast, modular audio accessory 208 may be stored and charged between uses, so that the required battery capacity of battery 210 may be no greater than that required to support one or a few calls. As a result, battery 210 may be substantially smaller than battery 110, and modular audio accessory 208 may be made correspondingly smaller than mobile headset 108. Reduction in the size of modular audio accessory 208 creates greater flexibility for its modular integration into mobile telephone 202. That, in turn, allows mobile telephone 202 to be made smaller while retaining its capacity to store and charge modular audio accessory 202. The additional reductions in scale made possible by some embodiments of the present invention further enhance portability of the mobile communication system as a whole.

Turning to FIG. 3, FIG. 3 shows mobile communication system 300 with modular audio accessory 308, according to another embodiment of the present invention. In the embodiment of FIG. 3, mobile communication system 300 includes cordless telephone handset 302 equipped with phone battery 304, and base/charger 306, corresponding respectively to mobile telephone 202 equipped with phone battery 204, and external phone charger 206, in FIG. 2A. Also shown in FIG. 3 is modular audio accessory 308, having battery 310 and power connector 312, corresponding respectively to modular audio accessory 208, battery 210, and power connector 212, in FIG. 2A. FIG. 3 also includes power port 314 and compartment 316, located on cordless telephone handset 302, corresponding to power port 214 and compartment 216 located on mobile telephone 202, in FIG. 2A.

In a manner similar to that for mobile communication system 200 shown in FIGS. 2A and 2B, in the embodiment of FIG. 3, modular audio accessory 308 can be stored, when not in use, by placement into compartment 316 in cordless telephone handset 302. In addition, power connector 312 on modular audio accessory 308 can be connected to power port 314, located in compartment 316, wherein battery 310 is charged by phone battery 304. As in FIG. 2A, dashed line 318 in FIG. 3 indicates that storage and charging configuration, as well as the fact that modular audio accessory 308 may be readily removed from compartment 316 for use. In the event that phone battery 304 becomes depleted, it may be charged by placement onto base/charger 306, as shown, in which event battery 310 of modular audio accessory 308 is concurrently charged through phone battery 304, when connected to power port 314.

Thus, the present invention enhances and extends the functionality of hands-free mobile communication systems, by increasing their portability and reducing their vulnerability to inoperability from a number of practical disadvantages associated with conventional implementations. By modular incorporation of an audio accessory into a mobile device, the present invention improves system portability and ease of use. By providing a fully integrated power source to support both a mobile device and a modular audio accessory, the present invention allows the modular audio accessory to be concurrently stored and charged when not in use. Integration of the power source offers the additional advantages of reduced modular audio accessory size, and decreased likelihood of hands-free system inoperability due to lost, misplaced, or discharged component devices.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. The described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A mobile communication system comprising:
a mobile communication device having a first battery and a compartment, said compartment having a power port connected to said first battery;
a modular accessory including a second battery, and said modular accessory configured for placement in said compartment, such that said second battery can be connected to said power port and charged through first battery;
wherein said second battery can be charged by said first battery when said modular audio accessory is placed in said compartment.

2. The mobile communication system of claim 1 wherein said mobile communication device is a cellular telephone.

3. The mobile communication system of claim 1 wherein said mobile communication device is a personal digital assistant (PDA).

4. The mobile communication system of claim 1 wherein said mobile communication device is a cordless telephone handset.

5. The mobile communication system of claim 1 wherein said modular audio accessory is a wireless headset.

6. The mobile communication system of claim 1 wherein said modular audio accessory is a wireless earpiece.

7. The mobile communication system of claim 1 wherein said modular audio accessory is a Bluetooth device.

8. A mobile communication device comprising:
a first battery;
an accessory compartment having a power port connected to said first battery and further configured to connect to a modular accessory;
wherein said accessory compartment enables said mobile communication device to store and charge said modular accessory when said modular audio accessory is placed in said accessory compartment.

9. The mobile communication device of claim 8 wherein said mobile communication device is a cellular telephone.

10. The mobile communication device of claim 8 wherein said mobile communication device is a personal digital assistant (PDA).

11. The mobile communication device of claim 8 wherein said mobile communication device is a cordless telephone handset.

12. The mobile communication device of claim 8 wherein said mobile communication device is a wireless computer.

13. The mobile communication system of claim 8 wherein said mobile communication device is a digital audio player.

14. The mobile communication device of claim 8 wherein said mobile communication device is a video game console.

15. A mobile communication system comprising:
a mobile communication device having a first battery and a compartment, said compartment having a power port;
a modular accessory including a second battery, and said modular accessory configured for placement in said compartment, such that said second battery can be connected to said power port;
wherein said second battery can be charged through said power port when said modular audio accessory is placed in said compartment.

16. The mobile communication system of claim 15 wherein said power port connects said first battery to said second battery.

17. The mobile communication system of claim 15 wherein said power port provides power to said second battery without connecting said first battery to said second battery.

18. The mobile communication system of claim 15 further comprises a single charger for charging both said first battery to said second battery.

19. The mobile communication system of claim 18 wherein said single charger charges both said first battery to said second battery concurrently.

20. The mobile communication system of claim 15 wherein said modular audio accessory is a Bluetooth headset.
